(19) United States
(12) Patent Application Publication
(10) Pub. No.: US 2012/0170024 A1
(43) Pub. Date: Jul. 5, 2012

(54) Long Range Acquisition and Tracking SWIR Sensor System Comprising Micro-Lamellar Spectrometer

(76) Inventors: Medhat Azzazy, Laguna Niguel, CA (US); James Justice, Newport Beach, CA (US); John Carson, Corona del Mar, CA (US); David Ludwig, Irvine, CA (US); Ying Hsu, San Clemente, CA (US)

(21) Appl. No.: 13/397,275

(22) Filed: Feb. 15, 2012

Related U.S. Application Data
(63) Continuation-in-part of application No. 13/010,745, filed on Jan. 20, 2011.
Application No. 13/010,745 is a continuation-in-part of application No. 13/372,184, filed on Feb. 13, 2012.
Application No. 13/372,184 is a continuation-in-part of application No. 12/924,141, filed on Sep. 20, 2010.
Application No. 13/372,184 is a continuation-in-part of application No. 13/108,172, filed on May 16, 2011.
Application No. 13/372,184 is a continuation-in-part of application No. 13/338,328, filed on Dec. 28, 2011.
Application No. 13/372,184 is a continuation-in-part of application No. 13/338,332, filed on Dec. 28, 2011.
(60) Provisional application No. 61/443,407, filed on Feb. 16, 2011.
(60) Provisional application No. 61/336,271, filed on Jan. 22, 2010.
(60) Provisional application No. 61/442,404, filed on Feb. 14, 2011.
(60) Provisional application No. 61/277,360, filed on Sep. 22, 2009.
(60) Provisional application No. 61/395,712, filed on May 18, 2010.
(60) Provisional application No. 61/460,173, filed on Dec. 28, 2010.
(60) Provisional application No. 61/460,172, filed on Dec. 28, 2010.

(51) Int. Cl. G01J 3/28; G01T 1/36

(52) U.S. Cl. 356/51; 356/402; 356/326; 250/393

(57) ABSTRACT

A sensor system is provided having a precision tracking sensor element and a micro-lamellar spectrometer for determining the wavelength of an electromagnetic source such as a laser designator source. Acquisition sensor elements may be provided and mounted on a rotating base element that rotates about a first axis. The precision tracking sensor elements may be mounted on a hinged or pivoting element or gimbal on the housing and provided with drive means to permit a user to selectively manually or automatically direct it toward a scene target of interest detected by the acquisition sensor elements. At least one of the imaging elements in the precision tracking sensor or acquisition sensors is stacked micro-channel plate focal plane array element.

### CROSS-REFERENCE TO RELATED APPLICATIONS

This application claims the benefit of U.S. Provisional Patent Application No. 61/443,407, filed on Feb. 16, 2011 entitled “Long Range Acquisition and Tracking SWIR Sensor System” pursuant to 35 USC 119, which application is incorporated fully herein by reference.

This application is a continuation in part application of U.S. patent application Ser. No. 13/010,745 entitled “Large Displacement Micro-lamellar Grating Interferometer” filed on Jan. 20, 2011 which in turn claims priority to Provisional Patent Application No. 61/336,271, filed on Jan. 22, 2010 entitled “Micro Lamellar Grating Interferometer” pursuant to 35 USC 119, which applications are fully incorporated herein by reference.

This application is a continuation in part application of U.S. patent application Ser. No. 13/372,184 filed on Feb. 13, 2012 entitled “LIDAR System Comprising Large Area Micro-channel Plate Focal Plane Array” which in turn claims the benefit of U.S. Provisional Patent Application No. 61/442,404, filed on Feb. 14, 2011 entitled “LADAR System Comprising Large Area Focal Plane Array and Risley Prism Beam Steering” pursuant to 35 USC 119, which applications are incorporated fully herein by reference.

This application is a continuation-in-part application of U.S. patent application Ser. No. 12/924,141 entitled “Multi-layer Photon Counting Electronic Module”, filed on Sep. 20, 2010, which in turn claims priority to U.S. Provisional Patent Application No. 61/277,360, entitled “Three-Dimensional Multi-Level Logic Cascade Counter” filed on Sep. 22, 2009, pursuant to 35 USC 119, which applications are incorporated fully herein by reference.

This application is a continuation-in-part application of U.S. patent application Ser. No. 13/108,172 entitled “Sensor Element and System Comprising Wide Field of View 3-D Imaging LIDAR”, filed on May 16, 2011, which in turn claims priority U.S. Provisional Patent Application No. 61/395,712, entitled “Autonomous Landing at Unprepared Sites for a Cargo Unmanned Air System” filed on May 18, 2010, pursuant to 35 USC 119, which applications are incorporated fully herein by reference.

This application is a continuation in part application of U.S. patent application Ser. No. 13/338,328 entitled “Stacked Micro-channel Plate Assembly Comprising a Microlens” filed on Dec. 28, 2011 and which claims priority to U.S. Provisional Patent Application No. 61/460,173, filed on Dec. 28, 2010 pursuant to 35 USC 119, which applications are incorporated fully herein by reference.

This application is a continuation in part application of U.S. patent Ser. No. 13/338,332 entitled “Sensor System Comprising Stacked Micro-Channel Plate Detector” filed on Dec. 28, 2011 which application claims priority to U.S. Provisional Patent Application No. 61/460,173, filed on Dec. 28, 2010 and entitled “Micro-channel Plate Assembly for Use With an Electronic Imaging Device” and to U.S. Provisional Patent Application No. 61/460,172 filed on Dec. 28, 2010 entitled “Micro-channel Plate Assembly Comprising Micro-lens” pursuant to 35 USC 119, which applications are incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic imaging systems.

More specifically, the invention relates to a LIDAR system comprising a large area focal plane array (“FPA”) having a multi-layer, micro-channel plate (MCP) electronic module which may, in an alternative embodiment, comprise a collimating micro-lens and Risley prism beam steering or receiving optics and in a preferred embodiment, comprises a laser designator spectrometer means using a micro-lamellar spectrometer.

2. Description of the Related Art

Miniaturized electro-optical sensors mounted on small unmanned air vehicles (“UAV's”) or unmanned aerial systems (“UAS's”) are potentially exploited by an adversary to obtain information on a military operation and its states of activity and readiness which may degrade the effectiveness of the operation.

What is needed is a cost-effective, deployable system to detect, track, identify, and enable interdiction of an adversary's UAS prior to the adversary having the ability to observe and report critical dispositions and activities.

As an emerging threat, small UAS's pose a difficult detection systems problem. First, the use of nonmetallic materials and particular shapes and geometries of an adversary's UAS results in poor detection performance of prior art, wide-area search radars due in part to low radar cross-section or “RCS” as has been confirmed in field tests.

Secondly, prior art acoustic search and detection approaches are likewise significantly impaired where battery-operated electric motors are used on a UAS for propulsion. A third detection difficulty is that neither of the radar or acoustic techniques provides inherent target ID capabilities.

Existing passive, electro-optical sensors can perform surveillance and target ID, but only at limited ranges and perform best only in daylight. Finally, the relatively small UAS infrared signatures severely limit detection ranges of cost-effective IR sensors.

An inherent “asymmetric advantage” for adversary forces lies in the fact that a simple UAS can be small, made of nonmetallic materials and can fly quietly using battery-powered electric motors. The use of broadly available IR sensors gives the adversary UAS a 24/7 operating capability. The relatively low cost of such systems ultimately imposes a requirement that the detection solution must also be cost-effective.

Thus the emerging threat is a small, difficult to observe, inexpensive vehicle that is capable of 24/7 operation.

The disclosed sensor system of the invention provides the means to deny an adversary the reconnaissance capabilities available in a UAS carrying readily available, passive visible and infrared sensors that could be deployed by enemy forces.

The disclosed invention is responsive to threat observables and operating timelines, supportive of all military response functions of wide area search, detect, track, ID, and interdiction to maximize “keep out” zones and accomplishes the needed detection solution in a fashion that is rugged, broadly operable, easily deployable and cost effective. A “keep out” zone of ≧6 Km diameter can be enforced for very small (0.1 m²) threat UAS of the WASP class using the invention.

Applicant's sensor system exploits high pulse rate, eye-safe SWIR fiber lasers, agile beam steering and very high sensitivity, large area focal plane arrays (FPAs) with stacked read-out integrated circuits (ROICs) using a multi-FPGA, high-throughput, low-power signal processor to provide a wide area, moderate resolution search volume for initial acquisition and tracking of an intruder UAS followed by a hand-over to a higher resolution 3D imaging LIDAR for target ID and precision tracking to support interdiction.

As earlier discussed, as an emerging threat, small UAS have the potential for posing a difficult systems problem. Use of nonmetallic materials and particular shapes can result in making traditional wide area search radars perform poorly due to low RCS. This problem is confirmed in U.S. Army sponsored field tests. Acoustic search and detection approaches are likewise significantly impaired if battery operated electric motors are used for propulsion. Neither of these techniques provides inherent target ID capabilities. Passive, electro-optical sensors can perform surveillance and target ID, but at limited ranges and only in daylight. Small UAS infrared signatures severely limit detection ranges of cost effective sensors.

A new detector design paradigm is needed. The disclosed invention enables that paradigm in a practical, cost-effective solution to the above deficiencies in the prior art and takes advantage of high performance micro-channel plate FPA imager technology.

### BRIEF SUMMARY OF THE INVENTION

A sensor system is provided comprising a precision tracking sensor element and one or more acquisition sensor elements. The acquisition sensor element preferably has a larger field of view with corresponding lower resolution than the precision tracking sensor element which preferably has a relatively small field of view for each of its independent active and passive imaging photo-detector elements but having higher resolution.

The acquisition sensor elements may be mounted on a rotating base element that rotates about a first axis to provide 360 degree detection about the first axis. The precision tracking sensor elements may be mounted on a hinged or pivoting element or gimbal on the housing and provided with automatic/computerized or manually controlled electronic drive means or both to permit a user to selectively manually or automatically direct the precision tracking sensor element toward a scene or target of interest detected by the acquisition sensor elements.

In a first aspect of the invention, a sensor system is provided comprising a first precision tracking element comprising imaging means for providing an electromagnetic illumination beam. The electromagnetic beam may have a predetermined imaging wavelength. The sensor system may have at least one precision tracking photo-detector element, an acquisition sensor element comprising at least one acquisition photo-detector element, wherein at least one of the photo-detector elements comprises an electronic module. The electronic module may comprise a stack of layers wherein the layers comprise a micro-lens array layer having at least one individual lens element for providing a beam output, a photocathode layer for generating a photocathode electron output in response to a predetermined range of the electromagnetic spectrum, a micro-channel plate layer comprising at least one micro-channel for generating a cascaded electron output in response to the photocathode electron output, and, a readout circuit layer for processing the output of the micro-channel.

In a second aspect of the invention the acquisition sensor element is mounted on a rotating base element that rotates about a first axis.

In a third aspect of the invention, the precision tracking sensor element is movably mounted to a housing to permit the selective direction toward a predetermined scene of interest.

In a fourth aspect of the invention, the sensor system further comprises at least one Risley prism assembly.

In a fifth aspect of the invention, the sensor system comprises Gray code counter circuit means.

In a sixth aspect of the invention, a sensor system is provided comprising a first precision tracking element comprising imaging means for providing an electromagnetic illumination beam having a predetermined imaging wavelength. The precision tracking element comprises scanning means for scanning the illumination beam on a target, a parabolic reflector element, a hyperbolic reflector element, beam-splitting means, a first precision tracking photo-detector element responsive to a predetermined first range of the electromagnetic spectrum having a first active field of view. The precision tracking element comprises a second precision tracking photo-detector element responsive to a predetermined first range of the electromagnetic spectrum having a first passive field of view. The sensor system further comprises at least one acquisition sensor element comprising an acquisition photo-detector element having a second field of view. At least one of the photo-detector elements in the precision tracking sensor element or in the acquisition sensor element or both comprises an electronic module comprising a stack of layers wherein the layers comprise a micro-lens array layer comprising at least one individual lens element for providing a beam output, a photocathode layer for generating a photocathode electron output in response to a predetermined range of the electromagnetic spectrum, a micro-channel plate layer comprising at least one micro-channel for generating a cascaded electron output in response to the photocathode electron output, and, a readout circuit layer for processing the output of the micro-channel.

In a seventh aspect of the invention, the parabolic reflector element and the hyperbolic reflector element are configured as a Cassegrain reflector telescope assembly.

In an eighth aspect of the invention, the illumination beam is projected through and incoming electromagnetic radiation is received through a common aperture.

In a ninth aspect of the invention, at least one of the first and second precision tracking photo-detector elements comprises an electronic module comprising a stack of layers wherein the layers comprise, a micro-lens array layer comprising at least one lens element for providing a beam output, a photocathode layer for generating a photocathode electron output in response to a predetermined range of the electromagnetic spectrum, a micro-channel plate layer comprising at least one micro-channel for generating a cascaded electron output in response to the photocathode electron output, and, a readout circuit layer for processing the output of the micro-channel.

In a tenth aspect of the invention, the readout circuit layer comprises a first sub-layer and a second sub-layer that are electrically coupled by means of a through-silicon via.

In an eleventh aspect of the invention, the sensor system further comprises a thermoelectric cooling layer.

In a twelfth aspect of the invention, the beam output of the lens element is substantially collimated.

In a thirteenth aspect of the invention, the readout layer is comprised of a set of readout sub-layers comprising a capacitor top metal and analog preamp sub-layer, a filtering and comparator sub-layer and a digital processing sub-layer.

In a fourteenth aspect of the invention, the predetermined ranges of the electromagnetic spectrum comprise ranges selected from the ultraviolet, visible, near-infrared, short-wave infrared, medium-wave infrared, long-wave infrared, far-infrared and x-ray ranges of the electromagnetic spectrum.

In a fifteenth aspect of the invention, the micro-channel plate is comprised of at least one micro-channel having a diameter of less than about 10 microns.

In a sixteenth aspect of the invention, the micro-channel plate is comprised of at least one micro-channel having a diameter of less than about five microns.

In a seventeenth aspect of the invention, the acquisition sensor is mounted on a rotating base element that rotates about a first axis.

In an eighteenth aspect of the invention, the precision tracking sensor element is movably mounted to a housing so as to be selectively directed toward a predetermined scene of interest.

In a nineteenth aspect of the invention, the sensor system further comprising at least one Risley prism assembly.

In a twentieth aspect of the invention, the Risley prism embodiment further comprises Gray code counter circuit means.

In a twenty first aspect of the invention, the sensor system may comprise spectrometer means for the detection and analysis of an incoming imaging laser source and for determining the wavelength of an electromagnet imaging source.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a focal plane array photo-detector element comprising a micro-channel plate of the invention.

FIG. 1a in depicts a block diagram of the major circuit elements of the layers or tiers of the photo-detector element of FIG. 1

FIG. 2 depicts an individual pixel element of the photo-detector element of FIG. 1 comprising a micro-lens and individual micro-channel.

FIG. 3 depicts a sensor system of the invention having a plurality of acquisition sensor elements on a rotating base element and a precision tracking element moveably mounted on the upper surface thereof.

FIG. 4 depicts a preferred embodiment of the precision tracking element of the sensor system of the invention in a multiple wavelength, multiple photo-detector, Cassegrain telescope configuration comprising a micro-lamellar spectrometer of the invention.

FIG. 4a depicts a further preferred embodiment of the sensor system of the invention having a Risley prism scanning and receiving assembly comprising a micro-lamellar spectrometer of the invention.

FIG. 5 is a flow chart showing schematically the major elements of a calculation for the signal-to-noise ratio of the sensor system of the invention.

FIG. 6 is a graph showing system performance in a clear atmosphere.

FIG. 7 is a graph showing system performance in a light rain.

FIGS. 8a and 8b depict two optical ray paths in a Risley prism set with the lenses in the prism set oriented in different positions.

FIG. 9 depicts a cross-section of the moveable and stationary mirror elements of the interferometer of the invention.

FIG. 9A is an interferogram of monochromatic light.

FIG. 10 illustrates a plan view of the interferometer of the invention comprising magnetic actuator means.

FIG. 10A is a perspective view of the interferometer of FIG. 10.

FIG. 11 is a sectional view taken along 11-11 of FIG. 10.

FIG. 12 shows a side view of an alternative embodiment of the interferometer of the invention comprising thermal actuator means.

FIG. 13 is a side view of an alternative embodiment of the interferometer of the invention comprising piezoelectric actuator means.

FIG. 14 depicts an alternative embodiment of the sensor system of the invention having a dichroic filter element for directing an electromagnetic signal to a spectrometer.

FIG. 15 depicts a preferred embodiment of the sensor system of the invention mounted on a rotating base for the selective direction of the objective toward a scene of interest using azimuth drive means.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures wherein like references define like elements among the several views, Applicant discloses a sensor system comprising a large area micro-channel plate focal plane array (“FPA”).

The device of the invention preferably comprises a fiber laser operating in the short-wave infrared spectrum or SWIR (i.e., from about 0.9 to about 1.7 microns), eye-safe spectral band of 1.55 microns which beneficially provides the very high pulse rates (˜100's of KHz) needed to provide 360° surveillance coverage at ranges greater than 5 Km sufficient to allow timely detection, tracking, identification, and interdiction of a UAS.

Coupled with the use of fiber lasers, the invention comprises very large photo-detector focal plane arrays and related readout integrated circuits (“FPA” and “ROIC” respectively) configured in a stacked microelectronic module. In order for the relatively low “per pulse” energies of fiber lasers (<100 μwatts) to detect small adversary UAS at multiple kilometer ranges, large numbers of detectors with very high sensitivity (i.e., a few photons) and high dynamic range (>80 dB) are required and are provided in the invention.

Turning to the figures wherein like numerals define like elements among the several views, a multi-layer micro-channel plate assembly and module comprising a micro-lens layer structure for use in an imaging system and a sensor system are disclosed.

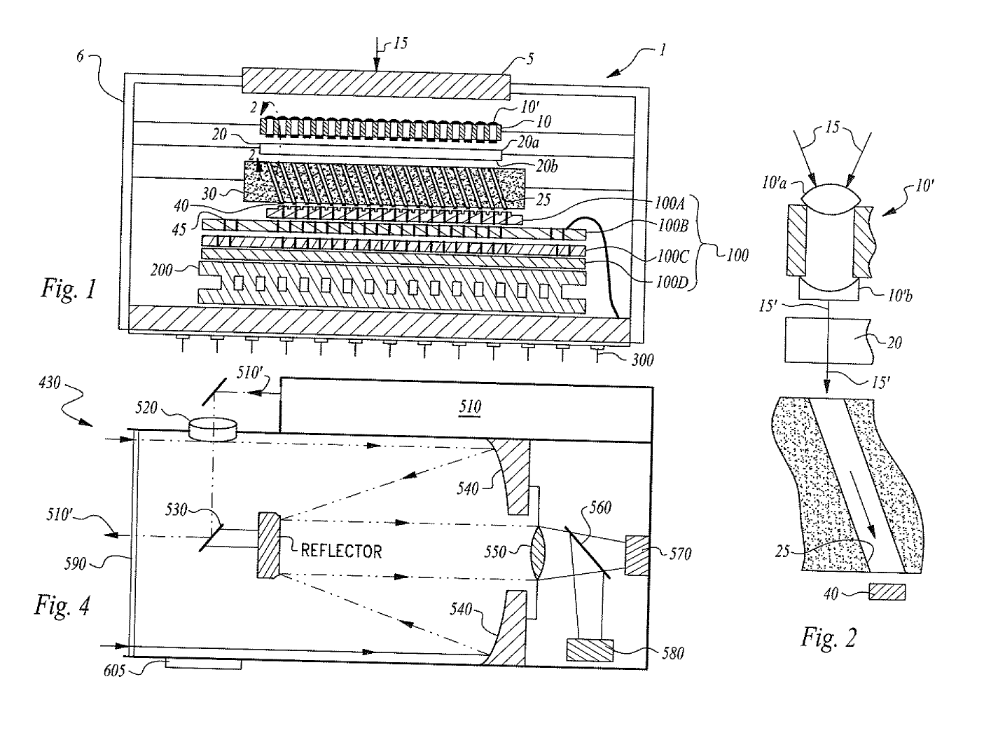

The photo-detector FPA of the device having such capabilities is illustrated in FIGS. 1 and 1a utilizing a high performance, stacked photo-detector element in the form of an FPA micro-channel plate module 1. Module 1 herein is interchangeably referred herein to as a photo-detector element 1.

Using the micro-channel plate module 1 of the invention, a relatively small photon arrival event will result in a large number of output electrons (i.e., a cloud of electrons) and provide increased photo-detector performance.

Turning to the preferred embodiment of the micro-channel plate module 1 of the invention shown in FIGS. 1 and 1a, micro-channel plate technology and readout integrated circuit (“ROIC”) technology are integrated into a three-dimensional, stacked plurality of microelectronic layers in the form of a stacked electronic photo-detector element or module to provide a high-circuit density structure for use in imaging applications.

Module 1 comprises a stack of microelectronic integrated circuit layers, each layer of which may comprise a plurality of sub-layers.

A window element 5 is provided in the preferred vacuum package enclosure 6 encasing module 1 for the receiving of electromagnetic radiation (i.e., reflected or emitted light or electromagnetic energy) from a scene of interest. Window element 5 may be comprised of a fused silica or sapphire material suitable for transmitting a predetermined received wavelength selected by the user.

Incident electromagnetic radiation from the scene of interest is received through window 5 by the micro-lens array layer 10.

In the illustrated embodiment, micro-lens array 10 comprises a plurality of individual lens elements 10′.

Individual lens elements 10′ may further each comprise a plurality of lens sub-elements such as a biconvex lens sub-element 10′a in optical cooperation with a plano-concave lens sub-element 10′b depicted in FIG. 2. Individual lens elements 10′ of micro-lens array 10 receive incident radiation 15 from the scene and collect and collimate it to provide a focused and collimated micro-lens array output beam 15′.

Micro-lens array 10 may comprise a two-dimensional array of individual lens elements 10′ wherein each lens element has a diameter of about 0.05 to about 3 mm and a local length of about 0.2 or 20 mm or may be provided to have a tunable focal length.

A photocathode layer 20 is provided and has an input surface 20a and an output surface 20b. Photocathode layer 20 produces an electron output in response to an input of a predetermined range of the electromagnetic spectrum received from the lens element 10′. In a preferred embodiment, the photocathode layer 20 comprises an indium gallium arsenide material or InGaAs and is responsive to electromagnetic radiation in the infrared spectrum or IR.

The collimated micro-lens beam output 15′ is incident upon the input surface 20a of photocathode layer 20 and produces an electron output in response thereto. Because the photon input to photocathode layer 20 is substantially collimated by the plurality of multiple lens elements 10′ of micro-lens array layer 10, the electron output of photocathode layer 20 is substantially focused and defined so as to be received within individual channels 25 of micro-channel plate assembly layer 30 rather than striking the inactive area of the micro-channel plate surface.

The diameter of the individual lens elements 10′ is preferably greater than that of the diameter of channels 25 in micro-channel plate 30 in order to capture and redirect incident radiation from the scene that would ordinarily strike the inactive micro-channel plate array surface and instead is directed into the individual channels 25.

Photocathode layer 20 serves to convert input photons of a predetermined frequency or wavelength from a scene of interest into output electrons which exit the photocathode and are received by channels 25 disposed through the thickness of micro-channel plate 30.

Photocathode 20 comprises a charged electrode that when struck by one or more photons, emits one or more electrons due to the photoelectric effect, generating an electrical current flow through it.

The channels 25 are disposed in the micro-channel plate structure material such that they substantially parallel to each other and in preferred embodiments are defined at a predetermined angle relative to the micro-channel input surface and micro-channel output surface of micro-channel plate 30.

As is known in the field of micro-channel plate technology, channels 25 function as electron multipliers acting as pixels when under the presence of an electric field. In operation, an electron emitted from photocathode layer 20 is admitted to the input aperture of channel 25 of micro-channel plate layer 30. The configuration of channels 25 assures the electrons will strike the interior wall or walls of channels 25 because of the angle at which the channels 25 are disposed with respect to planar surface of the micro-channel plate layer 30.

In operation, the collision of an electron with the interior walls of channel 25 causes an electron “cascading” effect, resulting in the propagation of a plurality of electrons through the channel and toward micro-channel layer output aperture.

The cascade of electrons exits the micro-channel layer output as an electron “cloud” whereby the electron input signal is amplified (i.e., cascaded) by several orders of magnitude to generate an amplified electron output signal.

Design factors affecting the amplification of the electron output signal from micro-channel plate 30 include electric field strength, the geometry of channels 25 and the micro-channel plate device material.

Subsequent to the electron output signal exiting a channel 25, the micro-channel plate 30 recharges during a refresh cycle before another electron input signal is detected as is known in the field of micro-channel plate technology.

The amplified electron output signal from channel 25 comprising a cascaded plurality of electrons is received by an electrically conductive member 40 that is electronically coupled with appropriate readout circuitry.

The electrical coupling of the layers or sub-layers or both in the readout circuitry layer may be such as by electrically conductive through-silicon vias 45 disposed within or between the sub-layers.

The photocathode layer 20 output surface is disposed proximal and coplanar with micro-channel layer 30 input surface whereby when a photon strikes photocathode layer 20 input surface, one or more electrons are emitted thereby and enter a channel 25 disposed through the micro-channel plate, generating an electron cascade effect and defining a photon arrival event. The electrons generated by the photon arrival event are processed by elements of the stacked assembly and the micro-channel plate output is processed using suitable circuitry whereby an image is produced.

The photocathode and micro-channel plate of the invention are available from Hamamatsu or Photonis (Burle) and are preferably integrated as a stack of layers with the ROIC. In one embodiment, the micro-channel plate may be optimized using atomic layer deposition (ALD) films for conductive secondary electron emission, photocathode and stabilization layers to simplify integration.

The three-dimensional stacked microelectronic architecture of the invention permits considerably lower detector size in part due to the use of small circuits and through-silicon-via (TSV) technology to electrically couple the layers of the invention while maintaining high frame rates and five micron pixel sizes.

The invention may comprise a plurality of stacked and interconnected sub-layers in the form of integrated circuit chips that define a readout circuit layer 100. In the illustrated embodiment, readout circuit layer 100 comprises a plurality of sub-layers, here illustrated in FIGS. 1 and 1a as sub-layers 100A-D.

Tier 1 shown as sub-layer 100A may comprise preamplifier circuitry for noise reduction, improved signal-to-noise ratio, preprocessing and conditioning the output of the micro-channel layer 30 and may comprise a capacitor top metal and analog preamp circuitry.

Tier 2 shown as sub-layer 100B may comprise one or more differentiator circuits having an output received by a zero-crossing comparator with an addressable record input and may comprise filtering and comparator circuitry.

Tiers 3 and 4 shown as sub-layers 100C and 100D respectively comprise digital processing circuitry.

Sub-layer 100C may comprise a resettable Gray code counter with an input into a first memory register.

Sub-layer 100D may comprise a second memory register and multiplexing circuitry for multiplexing the output of the module to external circuitry.

The sub-layers 100A-D may be electrically coupled using through-silicon via 45 technology, wire-bonding, side-bussing using metallized T-connect structures or equivalent electrical coupling means used to electrically couple stacked microelectronic layers.

A thermoelectric cooler layer 200 may be provided in the module for temperature stabilization of the module and stacked circuit layers.

The module 1 may further be provided in the form of a pin grid array package interface 300 for electrical connection to external circuitry such as using a socketed connection.

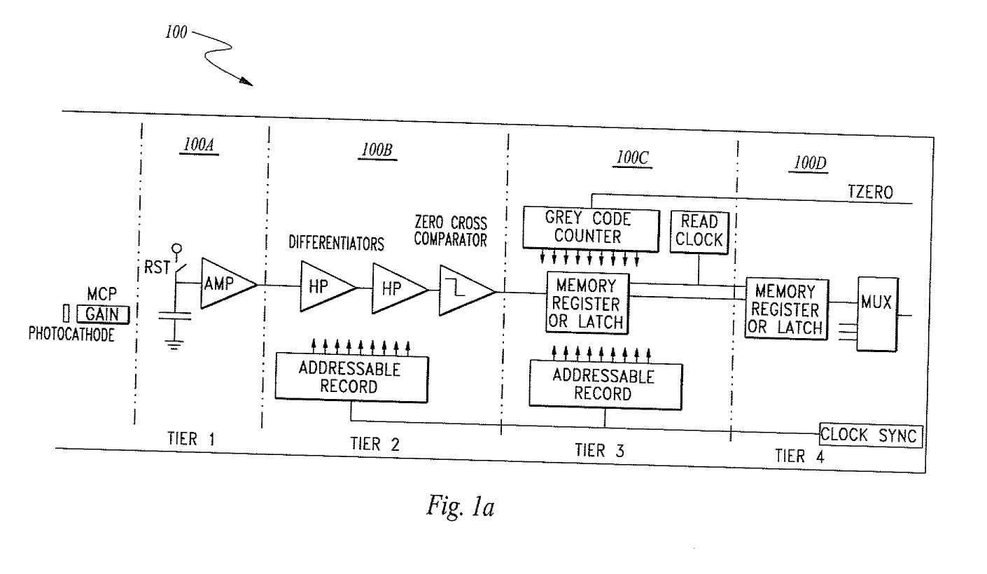

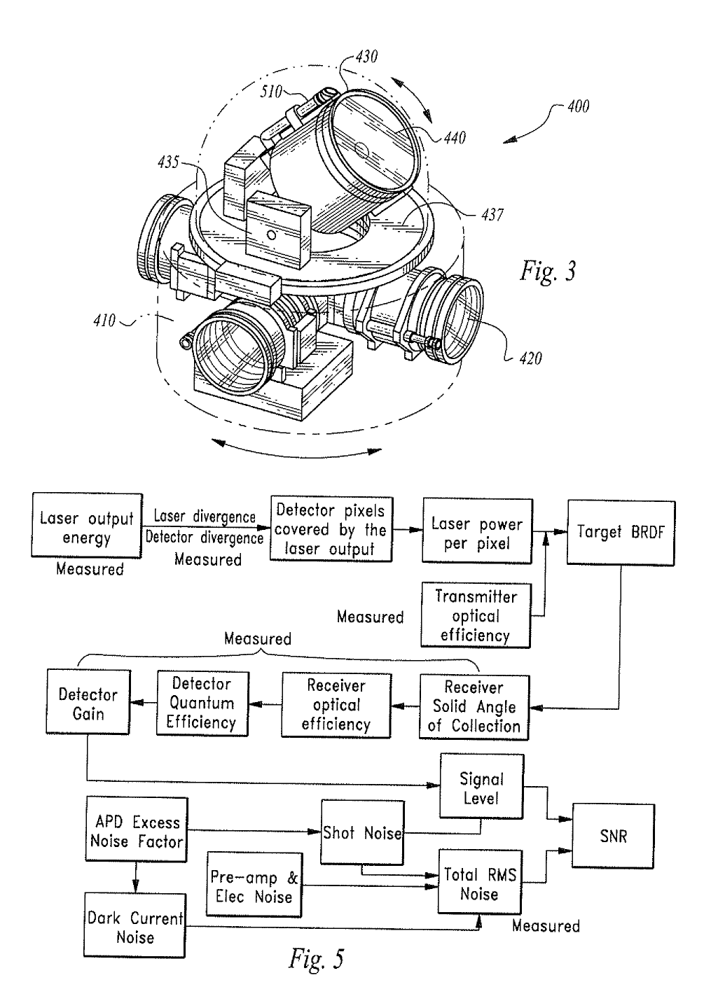

The sensor system of the invention preferably uses the illustrated four tier stacked approach for the physical implementation of the LIDAR focal plane as depicted in FIG. 3 as is more fully discussed below. The stacking design rules, based on Tezzaron's Through-Silicon-Via (TSV) technology, allow the real estate necessary to implement the silicon electron detector, analog preprocessing and digital time of arrival post processing all within about a 12 micron unit cell.

Ninety nanometer silicon design rules allow 2 GHz signal speed and approximately 80 transistors per tier. In one embodiment, 2048 elements in the long direction result in an active area die width of about 24.5 mm.

Echo photons from a laser-illuminated target are reflected from a target surface and strike the SWIR-responsive photocathode of module 1. The photocathode emits electrons with a quantum efficiency of about 0.15. The electrons are amplified by the micro-channel plate 30 with a gain of about 100,000. Thus the sensitivity of the focal plane module 1 is about seven photons. The micro-channel plate 30 can be delineated into channels 25 approaching five microns for very fine resolution amplification. The gain of the micro channel plate 30 can be increased by increasing time from the T_{zero} timing signal, providing low gain for close objects and high gain for far objects, extending the non-distorting dynamic range of the system.

The amplified electrons are captured by the top metal of a capacitor in the unit cell on tier 1. The voltage built up on the capacitor is sensed by a preamp in the tier 1 active layer connected by a through silicon via or TSV 45. Each TSV 45 for each unit cell takes up about 11% of the real estate, leaving approximately space for about 60 to 70 transistors per tier. The memory latch or register requires approximately nine transistors per bit, thus two tiers are adequate for 10-12 bits.

The readout circuit electrical architecture is based on simple LIDAR time of flight clocking concept and is depicted in the block diagram of FIG. 1a. A 10-bit clock, located outside the unit cell, is started counting by the T_{zero} pulse generated at the laser pulse signal. This counter feeds a 10-bit memory latch or register located inside each unit cell. When the echo is detected, the memory latch or register is triggered to capture the current count of the counter. The counter increments in a Gray code fashion to assure that only one bit is changing per clock cycle, saving power.

The echo pulse is integrated on the capacitor in tier 1. After simple buffering, the signal is turned back into a pulse via a high pass filter that acts as a differentiator. A second high pass filter changes the waveform again to a signal that passes through zero. The final analog component is a comparator that changes state from 0 to 1 by a signal that crosses through zero. Tier 1 in the illustrated embodiment is comprised of an electron detection capacitor, simple buffer amp and reset switch.

Tier 2 contains the three analog components; two high pass filters and comparator.

Tier 3 and Tier 4 contain the memory registers or latches. The memory is sized to save up to 1024 range bins of data. The high pass filters and zero cross comparator will yield a range resolution dependent on the clocking frequency of the 10-bit Gray code counter regardless of the pulse width of the laser. A 2 GHz master clock will result in 7.5 cm range resolution. The double differentiated waveform will also cross zero at the peak of the echo return.

The four-tier stack of FIG. 1a may comprise an 8-bit memory latch or register in the form of a Gray code memory latch or register in one or more of the unit cells.

A prior art LIDAR ROIC contained a FIFO that captured the state of the comparator, converting time of return into digital ones within the FIFO. This technology stored multiple returns from a single cell but required significant real estate and consumed significant power.

The circuit design topology of the invention is to fit each unit cell with one or two memory-type latches. The latch is fed with a counter. When the comparator changes states, the latch captures the numerical value of the counter at that instant. This represents a time-to-digital converter.

The ROIC may be provided with only one counter for the entire focal plane of the invention and only one latch per unit cell. In the instant memory latch of the invention, the counter counts in Gray code instead of binary code and as a result only one bit will ever change per clock cycle. This provides a significant power-saving feature.

An example of decimal, binary and Gray code count is

| Dec | Gray | Binary |
|---|---|---|
| 0 | 000 | 000 |
| 1 | 001 | 001 |
| 2 | 011 | 010 |
| 3 | 010 | 011 |
| 4 | 110 | 100 |
| 5 | 111 | 101 |
| 6 | 101 | 110 |
| 7 | 100 | 111 |

The depth of the latch is measured in bits. A 10-bit latch can store up to 1024 counts. For a clock that runs at 2 GHz, each count is 7.5 cm. Thus, the total range gate depth is approximately 75 meters.

This type circuit beneficially fits into very small unit cells. As depicted in FIG. 3, a four tier stack is illustrated that contains two digital tiers each with 4-bit latch. The unit cell size here is as small as 7.5 microns.

Each latch bit is 6-8 transistors, i.e., 64 transistors for an 8-bit latch. In the FIFO approach of the prior art ROIC, the number of transistors was about 6000 and each was required to change state with every return laser echo.

A key component of the LIDAR system is the fiber laser, such as is available from Aculight. This form of laser operates with a very fast pulse rate, up to >100 KHz, but each pulse only contains 100 micro-Joules. Operating in this manner, the laser is one of the most efficient eye safe lasers available. In order to obtain the maximum range, the beam spread of the laser is confined to 28×28 pixels. The beam is then rapidly stepped to the next 28×28 pixel location in the photo-detector element 1 after each pulse. The laser pulse is optically scanned due to its small aperture, 1 cm; the photo-detector element 1 is electrically scanned due to its relatively large optical aperture, 10 cm.

In this mode of operation, only a small percentage of the photo-detector element 1 is operating at any one time, permitting the addressable record feature to power manage the focal plane for low power operation. The multiplexer and output sections of the photo-detector element 1 are always powered providing a 10-bit parallel output.

The ROIC for this counter-UAV application-specific design dissipates less than 15 W which may require a thermoelectric or TE cooler 200 to stabilize the temperature of the ROIC stack.

The sensor system 400 of FIG. 3 comprises a rotating or fixed base member 410 having one or more acquisition sensor elements 420 disposed thereon having a first field of view. An exemplar aperture for the acquisition sensor elements 420 may be 10 cm having a first field of view of about 30 degrees elevation and about 0.23 degrees azimuth.

Turning to FIG. 3, sensor system 400 further comprises a precision tracking sensor element 430 having a second field of view. An exemplar aperture for the precision tracking sensor element 430 may be 20 cm having a second field of view for an active imager of about 0.11 degrees and a field of view for a passive imager of about 0.57 degrees.

In a preferred embodiment, the second field of view of the precision tracking sensor element 430 is greater than the first field of view of the acquisition sensor elements 420. Precision tracking sensor element 430 may be rotatably mounted on a hinge or gimbal 435 affixed to housing 437 to permit manual or automatic direction of the precision tracking sensor objective lens or aperture 440 toward a target. The precision tracking sensor element 430 or acquisition sensor element 420 or both comprise a photo-detector element 1 which are referred to herein as a precision tracking photo-detector element or elements and an acquisition sensor photo-detector element respectively.

Precision tracking sensor element 430 may comprise a first and second precision tracking photo-detector element for use in providing independent outputs from an optical beam-splitting element.

Further enhancing the performance of the sensor system 400 of the invention is the use of wide field-of-view optics: Rapid and large volume scanning requirements capable of detecting small UAS are met with wide FOV sensors which minimize mechanical requirements.

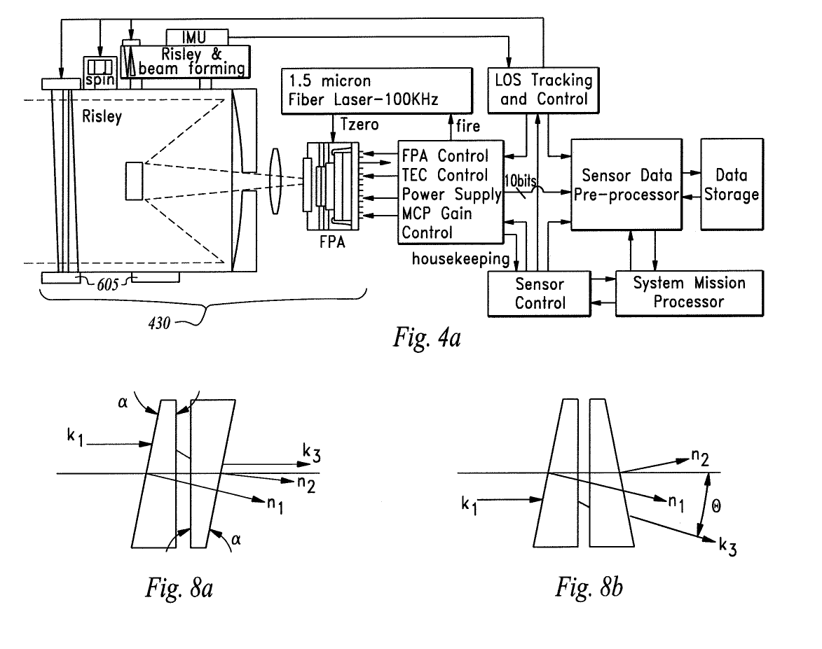

With respect to FIG. 4a, the precision tracking sensor system 430, here shown with a Risley prism, is controlled by the mission processor. Simple commands are decoded into the proper control by the sensor controller. Waveform generation takes place in the control function directly behind the FPA.

Output data from the sensor are pre-processed and stored in local memory for the mission process to access. The scanning control has dedicated interface that receives data from an IMU in addition to desired aiming commands.

Fiber lasers have been in the development for several years and have been making an impact in recently as a new laser source for applications. The fiber laser technology has the following advantages of being air cooled, not having thermal loading or role-over effects for the fiber, and no thermal lensing effects for the fiber.

The basic principle of a fiber laser is that the core of doped glass fiber is pumped by a diode laser of a specific wavelength and two Bragg gratings are etched into the fiber ends create the laser feedback cavity.

Several dopants and pump laser wavelength sources can be utilized to provide different wavelengths as shown in Table 1.

TABLE 1
Dopants and Fiber Laser Wavelength

| | Lasing wavelength |
|---|---|
| Dopant | (nm) |
| Ytterbium (Yb) | 1080 |
| Erbium (Er) | 1550 |
| Erbium/Ytterbium | 1550 |
| Neodymium (Nd) | 1064 |
| Thulium | 2000 |

In an alternative embodiment of FIG. 4a, the system of the invention exploits a wide FOV (e.g., 30°) sensor 430 which requires no elevation scanning and achieves azimuth scans by use of counter-rotating Risley prism optics. In this embodiment, no gimbals are required to achieve full search, detect, and initial tracking requirements.

Turning back to FIG. 4, a preferred embodiment of the configuration of the precision tracking element 430 and incorporating the micro-channel module 1 of the invention is disclosed.

Precision tracking sensor system 430 may comprise imaging means 510 for providing an electromagnetic illumination beam 510′ having a predetermined wavelength such as an eye-safe, four milli-joule laser source pulsed at 30 Hz with seven nanosecond pulse widths operating in about the 1.5 to about 2.0 micron region.

Precision tracking sensor system 430 may further comprise holographic beam-forming optics 520 and beam-scanning means 530 which may be in the form of a tip-tilt mirror assembly for scanning the illumination beam on a target in a field of regard.

Precision tracking sensor system 430 may comprise a parabolic reflector element 540 in optical cooperation with a hyperbolic reflector element 550.

Precision tracking sensor system 430 may comprise beam-splitting optical means 560 for the division of the received optical beam input into a first and second predetermined range of the electromagnetic spectrum.

Precision tracking sensor system 430 of the invention may comprise a first photo-detector element 570 responsive to a predetermined first range of the electromagnetic spectrum and a second photo-detector element 580 responsive to a predetermined second range of the electromagnetic spectrum. The first and second photo-detector elements 570 and 580 may each be selected to be responsive to predetermined ranges of the electromagnetic spectrum selected from the ultraviolet, visible, near-infrared, short-wave infrared, medium-wave infrared, long-wave infrared, far-infrared and x-ray ranges of the electromagnetic spectrum.

At least one of the first and second photo-detector elements may comprise a module 1 of the invention.

The parabolic reflector element 540 and the hyperbolic reflector element 550 are preferably configured as a Cassegrain reflector telescope assembly as is depicted in the various drawing figures.

The illumination beam 510′ is projected through and incoming electromagnetic radiation is received through a common aperture 590. The incoming electromagnetic radiation includes incoming visible and SWIR from the scene as well as the reflected laser echo from the target surface.

One or more optical notch or band-pass filters may optionally be provided between the beam-splitter and the first or second photo-detector elements or both to narrow the range of electromagnetic frequencies received by them from the split input beam.

The first and second photo-detector elements 570 and 580 may be provided in precision tracking sensor system 430 wherein at least one of the first and second photo-detector elements 570 and 580 comprises electronic module 1 comprising a stack of layers wherein the layers comprise a micro-lens array layer 10, a photocathode layer 20 for generating a photocathode electron output in response to a predetermined range of the electromagnetic spectrum, a micro-channel plate layer 30 comprising at least one channel 25 for generating a cascaded electron output in response to the photocathode electron output and a readout circuit layer 10 for processing the output of the micro-channel layer.

In a preferred embodiment, the disclosed system concept samples over 200 million pixels/sec. to provide required area search rates. Real-time processing of this data flow requires extremely high throughput processors with low power consumption in order to have a practical, affordable system. Applicant's innovative 3D stacked electronics technology enables a multi-FPGA, very high throughput solution.

The SNR calculation method for a preferred embodiment of the invention is schematically shown in FIG. 5 and in the following discussion; details are discussed on each one of the system elements illustrated.

The collected signal energy is calculated from the relationship:

$${E}_{s} = \frac{{E}_{L}}{{N}_{x} {N}_{y}} \cdot {η}_{T} \cdot {R}_{surface} \cdot \frac{Ω}{π} \cdot {η}_{R} \qquad ( 1 )$$

Where

| | | |
|---|---|---|
| Eₛ | Signal energy | J/pulse/pixel |
| E_{L} | Laser energy | J/pulse/pixel |
| Nₓ | Laser size in detector pixels (x-dir) | pixel |
| N_{y} | Laser size in detector pixels (y-dir) | pixel |
| [symbol] _{T} | Transmission efficiency | |
| R_{surface} | Surface BRDF—Lambertian | |
| Ω | Solid angle of collection | steradian |
| [symbol] _{R} | Receiver efficiency | |

The solid angle is calculated from the relationship

$$Ω = \frac{π}{4} \frac{{D}^{2}}{{Rn}^{2}} \qquad ( 2 )$$

Where

| | | |
|---|---|---|
| D | Aperture diameter | m |
| Rₙ | Range | m |

Notice that the solid angle in equation (1) is divided by [symbol] because the surface reflectivity is assumed to be constant and corresponds to a Lambertian surface.

The photon energy is calculated from

$${E}_{p h} = \frac{hc}{λ} \qquad ( 3 )$$

Where

| | | |
|---|---|---|
| Eₚₕ | Photon energy | J/photon |
| h | Planck's constant | J · sec |
| c | Speed of light | m/sec |
| λ | Laser wavelength | micron |

The number of signal photons, nₛ is then determined by dividing the signal energy by the photon energy, i.e.,

$${n}_{p h , s} = \frac{{E}_{s}}{{E}_{p h}} \qquad ( 4 )$$

The detector/electronic system bandwidth is designed to match the laser pulse time. The laser pulse width (full width at half maximum—FWHM) is one of the performance parameters. The bandwidth is determined from the laser pulse width using the relationship

$$B = \frac{0.5}{{t}_{rise}} \qquad ( 5 )$$

Where

| | | |
|---|---|---|
| B | System bandwidth | Hz |
| tᵣᵢₛₑ | Laser rise time | Sec |

The temporal distribution of the laser output is Gaussian. Therefore the laser rise time is the time taken to go from 0.1 to 0.9 of the maximum energy. Thus, for a Gaussian distribution

$$\begin{matrix}{t}_{0 , 1} = \sqrt{- 2 {σ}^{2} ln ( 0.1 )} & ( 6 ) \\ {t}_{0 , 9} = \sqrt{- 2 {σ}^{2} ln ( 0.9 )} & ( 7 ) \\ {σ}^{2} = \frac{- {t}_{0.5}^{2}}{2 ln ( 0.5 )} & ( 8 ) \\ {t}_{rise} = {t}_{0 , 1} - {t}_{0 , 9} & ( 9 )\end{matrix}$$

Where t_{0.5} is the half width at full maximum, and t_{0.9} is the standard deviation.

The atmospheric transmission efficiency for different environments is calculated using MODTRAN. In this analysis, Applicant has documented the results of two cases: (a) clear atmosphere, and (b) light rain (low density of water droplets). The model uses both Mie scattering and Dermendjian distribution to calculate the extinction coefficient as well as the MODTRAN output.

The number of signal electrons generated at the FPA anode is determined by the FPA quantum efficiency and gain through the relationship

n_{e,s}=n_{ph,s}η_{Q}GFₓ (10)

Where

n_{e,s} # of anode signal electrons

n_{ph,s} # of photons

[symbol] _{Q} APD quantum efficiency

G APD gain

Fₓ pixel fill factor

The dark current noise is usually divided into bulk and surface dark current noise. The surface dark current noise is very small and will be neglected. The bulk dark current is

I_{db}=InAmp (11)

Therefore the dark current noise is calculated from the relationship

[symbol]

_{n,dark}² [symbol] =2qI_{db}BG²F (12)

The dark current noise could be converted into a number of electrons using the relationship

$${n}_{dark \_ current}^{2} = \frac{〈 {i}_{n , dark}^{2} 〉}{{( 2 qB )}^{2}} \qquad ( 13 )$$

Where
[symbol] i_{n,dark}² [symbol] ensemble average of the square of the dark current noise
n_{dark} ensemble average of the dark current noise (electrons)
q Electron charge
I_{DB} Bulk dark current noise
B System bandwidth
G APD gain
F Excess noise factor

The shot noise arises from the random statistical Poissonian fluctuations of the signal electrons. The shot noise is calculated from

[symbol]

_{n,shot}² [symbol] =2qīₛBG²F (14)

Here, īₛ is the photo-electron current (before any gain or amplification). The shot noise is also calculated as a number of electrons using the relationship:

nₛₕₒₜ²=(n_{ph,s}η_{Q}Fₓ)G²F (15)

The FPA/electronic system total noise is the rms average of the sum of the squares of the individual noise. Thus

$${noise}_{total} = \sqrt{{n}_{shot}^{2} + {n}_{dark current}^{2} + {n}_{pre \text{-} amplifier}^{2}} \qquad ( 16 )$$

The signal to noise ratio is calculated from

$$SNR = \frac{\# of signal electrons}{\# of noise electrons} \qquad ( 17 )$$

The signal level is scaled with the range as:

$$\frac{{S}_{1}}{{S}_{2}} = {( \frac{{R}_{2}}{{R}_{1}} )}^{2} \qquad ( 18 )$$

Where Sᵢ is the signal at range Rᵢ. Therefore using the signal at the pivot range, the number of anode electrons n_{e,s} at any range Rn is calculated from:

$${n}_{e , s} = {n}_{e , s} {\vert}_{Pivot} \cdot {( \frac{{Rn}_{Pivot}}{Rn} )}^{2} \qquad ( 19 )$$

The shot noise is the only noise affected by the signal. Therefore the shot noise nₛₕₒₜ at any range Rn is calculated from the shot noise at the pivot range such that:

$${n}_{shot}^{2} = {n}_{shot}^{2} {\vert}_{Pivot} \cdot {( \frac{{Rn}_{Pivot}}{Rn} )}^{2} \qquad ( 20 )$$

Therefore the SNR becomes

$$SNR ( Rn ) = \frac{{n}_{e , s} {\vert}_{Pivot} \cdot {( \frac{{Rn}_{Pivot }}{Rn} )}^{2}}{\sqrt{{n}_{darkcurrent}^{2} + {n}_{pre \text{-} amplifier}^{2} + {n}_{shot}^{2} {\vert}_{Pivot} \cdot {( \frac{{Rn}_{Pivot}}{Rn} )}^{2}}} \qquad ( 21 )$$

Similarly, the scaling laws for the SNR for different reflectivities, R, could be expressed as:

$$SNR ( Rn , R ) = \frac{{n}_{e , s} {\vert}_{Pivot} \cdot {( \frac{{Rn}_{Pivot}}{Rn} )}^{2} \cdot ( \frac{R}{{R}_{Pivot}} )}{\sqrt{{n}_{darkcurrent}^{2} + {n}_{pre \text{-} amplifier}^{2} + {n}_{shot}^{2} {\vert}_{Pivot} \cdot {( \frac{{Rn}_{Pivot}}{Rn} )}^{2} \cdot ( \frac{R}{{R}_{Pivot}} )}} \qquad ( 22 )$$

The scaling laws for the different receiver aperture diameter are:

$$SNR ( Rn , R , D ) = \frac{{n}_{e , s} {\vert}_{Pivot} \cdot {( \frac{{Rn}_{Pivot}}{Rn} )}^{2} \cdot ( \frac{R}{{R}_{Pivot}} ) \cdot {( \frac{D}{{D}_{Pivot}} )}^{2}}{\sqrt{\begin{matrix}{n}_{darkcurrent}^{2} + {n}_{pre \text{-} amplifier}^{2} + {n}_{shot}^{2} {\vert}_{Pivot} \cdot \\ {( \frac{{Rn}_{Pivot}}{Rn} )}^{2} \cdot ( \frac{R}{{R}_{Pivot}} ) \cdot {( \frac{D}{{D}_{Pivot}} )}^{2}\end{matrix}}} \qquad ( 23 )$$

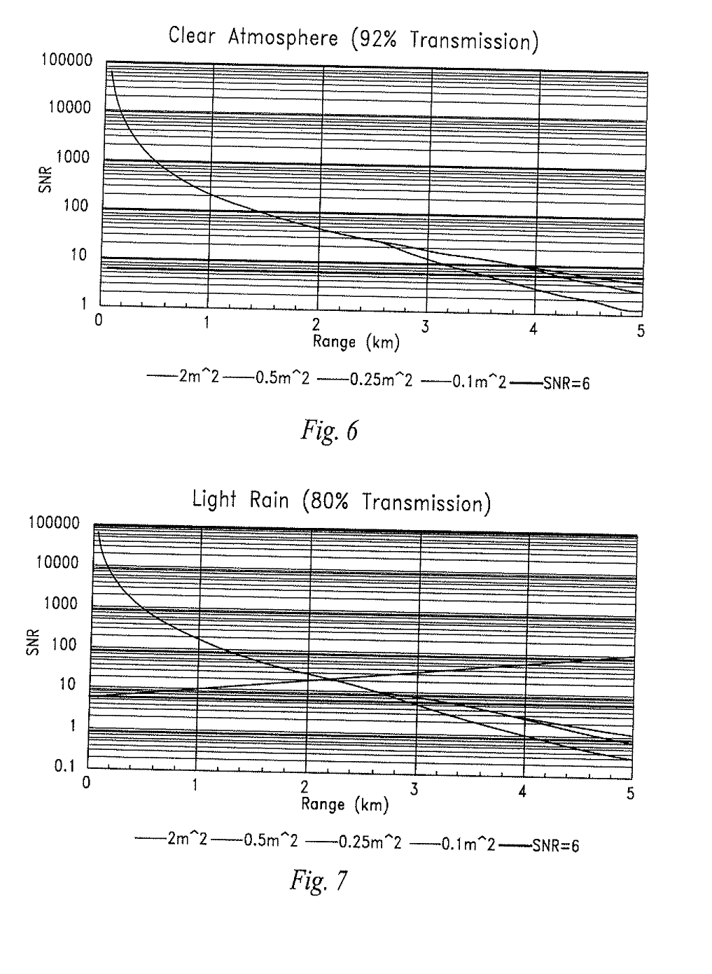

Using the above, the performance of a baseline precision tracking sensor system 430 is given in FIGS. 6 and 7 for different atmospheric conditions. The performance has been calculated for different target sizes: 2, 0.5, 0.25, 0.1 m² target area. The figures show that the system is capable of detecting the smallest targets at 3 kin distances with SNR=6.

This disclosed approach to tracking UAS's incorporates the foundation of Kalman filter theory and provides a sophisticated clutter rejection scheme. This target tracking theory employs the temporal sequence of position measurements to update a corresponding sequence of target state estimates.

The general UAS tracking idea is that target position at the next measurement time is first predicted on the basis of an underlying propagation model, and then this prediction is updated using the available measurement information. This two-step procedure is repeated for each new measurement. By using a dynamic system model with a large ‘process noise’ variance and a small ‘observation noise’ variance, the procedure can be tuned to rely more strongly on the observational (measurement) data and less strongly upon the propagation model.

Such tuning is appropriate for tracking UAS's which are subject to unknown forces (e.g., increased thrust or changes in aerodynamic forces due to the movement of control surfaces). Further, with such weak reliance on the propagation model, a relatively simple dynamic system model should suffice.

Two types of clutter are addressed: stationary echoes (e.g., reflections off buildings) and moving echoes (e.g., flying birds). A simple approach for eliminating stationary clutter is to define a horizon, for example from building top to building top in an urban environment, and only process data above that line. While this simple approach can effectively track high-azimuth targets, it fails to track low-azimuth targets. A more robust approach enables tracking of both high and low-azimuth targets. This approach develops a 3D map of fixed-position reflectors that are located in range as well as bearing and azimuth. Such a map enables tracking a UAS passing at low azimuth in front of local buildings. Moreover, when a UAS is obscured and its track is lost (e.g., when the UAS passes behind a local building), a user can reacquire its track once the UAS again becomes visible.

A key issue arising in environments with moving clutter is that of data association: during the update step, the tracking algorithm must choose which of the available measurements to associate with the current track. One way to address this issue is to simply associate the measurement that is closest to the predicted target position with the current track; however, if the UAS has undergone a maneuver, this closest measurement may well represent a clutter response and thereby lead to a tracking error.

Another approach is to spawn several tracks, each associated with a different measurement; if enough tracks are spawned, one will include the correct data association. The obvious challenge with this approach is to keep the number of tracks to a manageable level by (a) judiciously spawning new tracks, instead of exhaustively following all possible data associations, and (b) eliminating old tracks whose track-history appears inconsistent with UAS behavior. For example, over time, spurious tracks are likely to exhibit erratic movements with excessive velocities and/or accelerations. Further, a large number of tracks with a ‘parallel’ track history may be indicative of a flock of birds; such track groups can be tagged and, when they are sufficiently separated from the more interesting target tracks, eliminated.

This detection-tracking approach can be validated using a scenario simulator to generate synthetic laser data consistent with one or two realistic threats. The simulator may include a UAS flight model that can be programmed for realistic speed and heading maneuvers and incorporate the effects of wind. The simulated laser data is thus consistent with laser errors in 3D space to allow us to assess tracking performance versus laser targeting accuracy. The simulator also is used to compare threat tracking accuracy to the requirements for various interdiction solutions.

Target classification is based on threat size estimates and flight dynamics. The high resolution of the laser output guarantees multiple hits from the target from which an image profile can be constructed. Target tracks are used to estimate the aspect angle of the threat which is then be used to translate the imaging hits to threat dimensions. The images are refined over time as the target maneuvers and compared to a library of candidate UAS threats to select the most likely UAS model. In some cases, model identification can provide insight to the RF link to the UAS which enables the threat to be neutralized via jamming.

Once a threat has been identified, there are several possible interdiction reactions. One technique is to jam the communications link between the UAS and its operator to render it ineffective (thwart data download). The RF control link can also be jammed but a UAS flying via waypoints would not be impacted. The use of jamming may impact friendly RF-based systems so one needs to take into account the operational configuration. Selective jamming (i.e., spatially focused jamming) is a reasonable option.

The light returning from a small target may be very low level so the optics are optimized to efficiently capture the returning light for processing. This requires a large collection aperture for the wide field of view optics, and a beam steering mechanism to match the field of view to the illuminating laser. The latter may be accomplished by using a rotating Risley prism embodiment which permits fast field of view scanning with limited power requirements.

The collection optics of the Risley prism embodiment provides a large aperture to efficiently capture the light returning from a small target. As the field of view increases, the aperture decreases resulting in a tradeoff between FOV and aperture. A good balance is found with a 30° HFOV with a 100 mm diameter clear aperture. From this starting point, the specifications for a Risley embodiment are calculated as follows:

| | |
|---|---|
| Sensor Field of View | 30° × 0.25° |
| Sensor Clear Aperture Diameter | 100 mm |
| Optics IFOV | 128 microradians |
| Lens focal length | 115 mm |
| Lens F/# | F/1.2 |
| Lens resolution (as-built) | >20% MTF at 35 lpm |
| Compatible with FPA Size | 4,096 × 32 pixels |
| Compatible with FPA Pixel Pitch | 15 microns |
| Image circle diameter | 64 mm diameter |
| Spectral Coverage - ⁽¹⁾ | 1.53-1.58 microns |
| A Thermal ΔT Range For Design | −40° to +60° C. |
| Counter Rotating Wedges For Azimuth | ±45° |
| Scan (if using Risley prisms) | |
| Beam pointing accuracy | Better than 250 microradians |

⁽¹⁾ Fitered down to ~10 nanometers FWHM. Peak transmission of optics to occur in the region indicated.

Lens design is done using a least squares method for minimizing the merit values for the given input variables.

Because of this narrow-area scan design of the device, the lens field of view is scanned to match the illumination laser light. In one embodiment, this is accomplished through the use of counter rotating prisms allowing the beam to be steered +/−45°. This system of Risley prisms are illustrated in FIGS. 8a and 8b.

Generally, with the apex of the two prisms pointing in opposite directions, the prisms act as a parallel side plate of glass and impart no deviation to the light. This is the orientation when the illumination laser is at 0° (parallel) to the optical axis.

As the prisms rotate 90° about the optic axis, they end up with the apexes pointed in the same direction. In this case, the two prisms act as a single prism with an included angle equal to twice the included angle of either prism alone. This allows for maximum deviation of 45°.

Another 90° rotation and the prisms are pointing in opposite directions imparting no light deviation. Another 90° rotation aligns the apex angles again, this time diverting the light −45°. As the prisms rotate at a constant speed, the light deviation varies from +45° to −45° in a sinusoidal pattern.

This rotation must be accomplished quickly and smoothly. A dual stepper motor controls the speed and position of the prisms accurately to keep them aligned and in sync with the illumination laser. This motor is an integral part of the optical barrel design.

An exemplar Risley pair with the rotating prism shown at a 180 degree difference in position is shown in two views of FIGS. 8a and 8b.

The incoming light k₁ enters the prism pair on the left and is redirected in the direction of k₃. As shown in FIG. 8a, if the prisms have their wedge normals aligned, there is just translation of the output beam k₃ with respect to the input beam k₁. If the wedge normals are pointed opposite each other as shown in FIG. 8b, the output beam experiences a maximum elevation deviation. The direction cosines for a beam emerging from such a Risley pair are given below.

$$\begin{matrix}[ \begin{matrix}{k}_{3 x} \\ {k}_{3 y} \\ {k}_{3 z}\end{matrix} ] = [ \begin{matrix}cos φsin θ \\ sin φ sin θ \\ cos θ\end{matrix} ] = [ \begin{matrix}β sin α + cos φ sin α ⌊ \begin{matrix}\sqrt{1 - {n}^{2} + {γ}^{2} ( φ )} - \\ γ ( φ )\end{matrix} ⌋ \\ sin φ sin α [ \begin{matrix}\sqrt{I - {n}^{2} + {γ}^{2} ( φ )} - \\ γ ( φ )\end{matrix} ] \\ \begin{matrix}( I + β cos α ) + \\ cos α [ \sqrt{I - {n}^{2} + {γ}^{2} ( φ )} - γ ( φ ) ]\end{matrix}\end{matrix} ] \\ Where & ( 1 ) \\ β = \sqrt{{n}^{2} - {sin}^{2} α} - cos α \\ And & ( 2 ) \\ γ ( φ ) = cos α + β ( {cos}^{2} α + cos φ {sin}^{2} α ) & ( 3 )\end{matrix}$$

Where the angle is the azimuthal rotation between prisms.

Therefore, the Risley pair can be used to redirect a light beam to any elevation angle and azimuthal angle limited only by the wedge angle of the prisms, and given by the azimuthal rotation between prisms.

The sensor system of the invention also desirably provides a long range acquisition and tracking sensor suitable for assessment and warning of threats to space-based assets such as satellites.

Potentially hostile foreign powers are developing and demonstrating space operations capabilities that threaten the operability and survivability of critical space assets, such as communications, navigation, and intelligence satellites critical to defense capabilities.

Timely and accurate assessment and warning of potential satellite attacks are keys to preserving the operations of satellite systems. Early detection and accurate assessment are needed for threatening objects entering the proximity of satellites.

Core electro-optical technologies of the invention are optimized to permit long range threat detection (˜2,000 Km), accurate long range tracking (˜2,000 Km), and accurate assessment (˜1 cm resolution) when threats are in proximity of satellites. The size, weight and power (SWaP) of a preferred embodiment of the sensor is about 0.8 ft³, about 15 Kg and about 50 watts per unit which allow deployment on many satellites.

The invention provides full spherical alerting, warning, precision tracking, and target assessment capabilities around key satellite systems upon which it is deployed and has high sensitivity using passive visible sensors detect possible threats at ranges ˜2,000 Km when threats are sun-illuminated. The invention can provide target observations over a full 47π steradian sphere using two units each using passive visible and active SWIR imaging.

In one mode of operation of the embodiment disclosed in the figures, elevation pointing is achieved via a pair of counter-rotating Risley prisms (0-90 degrees) as discussed above. A turntable mounted on a gimbal system is used for azimuth pointing (0-360 degrees). Other major elements of this preferred embodiment of the invention may comprise:
A 15 cm aperture primary telescope,
A 512×512 mosaic micro-channel plate focal plane array module 1,
An agile tip-tilt mirror assembly for LOS stabilization,
A system controller,
A sidereal search mode processor, and,
A track rate mode processor.

One or more high pulse rate SWIR fiber lasers operating at 1.54 microns for volume surveillance are provided and operate in conjunction with one or more InGaAs and HgCdTe mosaic focal plane arrays with avalanche photodiode gain for active surveillance and active LIDAR 3D-imaging.

The four tier stack of high speed (˜2 GHz) read out integrated circuits (ROICs) above is used for 3D-imaging in the invention. Micro-channel plate visible FPA module 1 is integrated with a 3D-stack of layers of read out integrated circuits (ROICs) for passive surveillance. Two sensor component technologies are integrated to achieve the active search laser:

1. One or more high pulse rate (70 KHz), high pulse energy (62.5 μJ) fiber lasers operating at an eye-safe frequency of 1.54 microns (such as the Aculight Laser System),

2. A mosaic array of very high speed, low power sampling circuits (256×12 simultaneous channels) operating at high rates with rapid “on-of” mode.

The precision beam steering optical elements such as Risley prism sets are used to rapidly point the laser transmitter and receiver over the desired hemisphere of coverage.

In a yet further embodiment of the invention having the capability of providing laser designator analysis and warning (i.e., the ability to sense and analyze an attempt by an adversary to laser scan or image a satellite upon which the sensor system is mounted), detection spectrometer means such as a micro-lamellar interferometer functioning as a spectrometer are provided. The spectrometer means and suitable circuitry are provided on the sensor system of the invention for determining the wavelength of an electromagnetic imaging source such as an unauthorized laser imaging or designator source.

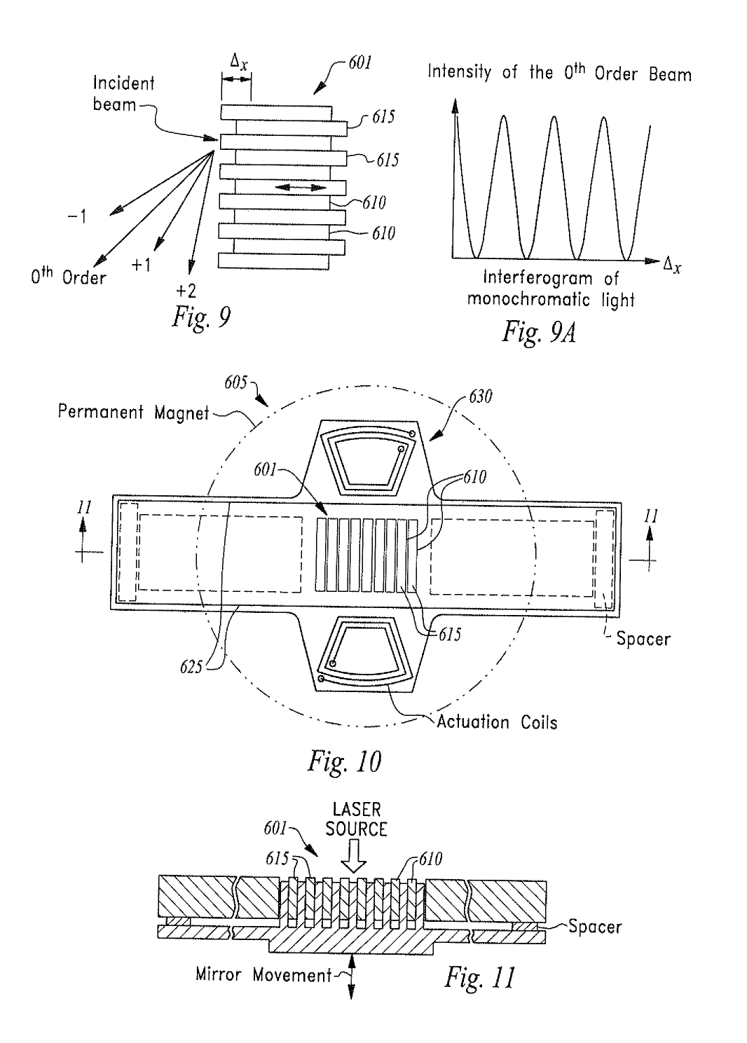

Turning to FIGS. 9-13 wherein like numerals define like elements among the several views, a micro-lamellar spectrometer grating structure 601 is disclosed that is suitable for use as a laser designation sensor with the sensor system of the invention.

It is expressly noted that while the disclosed micro-lamellar spectrometer is well-suited for use with the sensor system of the invention, the invention is not limited to the use of the illustrated micro-lamellar spectrometer in the figures and that any spectrometer means for determining the wavelength of an incoming electromagnetic beam such as a laser designator beam may be employed of acceptable SWaP and still fall within the scope of the claims.

The micro-lamellar spectrometer grating structure 601 operates by deriving the spectrum of an incident beam of electromagnetic radiation from, for instance, an adversary's laser imaging or designator source, using a generated interferogram.

The concept of a lamellar grating interferometer was invented by Strong and operates in the 0^{th} order of the grating as generally shown in FIGS. 9 and 9A. A brief explanation of the working principles of a lamellar grating interferometer is set out below.

An electromagnetic beam from a scene of interest of laser imaging source is incident on the lamellar grating 601 as shown in FIG. 9. By vertically displacing one set of mirror elements while keeping the other set of mirror elements in a fixed position, two electromagnetic radiation beams are generated and reflected from the grating having an optical path difference between them. The two sets of interleaved mirror elements divide the incident electromagnetic beam into two reflected beams; one by the stationary set of mirror elements and the other by the second set of moveable mirror elements. The optical path difference between the two reflected beams is created by the relative vertical displacement of the first and second sets of mirror elements shown as “depth (Δx)” in FIG. 9, resulting in an interference pattern that is a function of Δx.

The intensity of the 0^{th} order beam is modulated between a minimum and a maximum as Δx decreases and increases. An interferogram is generated by measuring the intensity of the 0^{th} order beam versus Δx. By applying a Fourier Transform to the measured interferogram, the light power spectrum of the incident beam may be then calculated. The resulting power spectrum of the incoming electromagnetic source may be compared against known spectra of laser sources stored in an electronic lookup table for identification.

Prior art MEMS-based lamellar grating interferometers have many deficiencies including the inability to reliably operate outside of the visible and near-IR wavelengths. Further, existing lamellar interferometers are extremely sensitive to shock and vibration such as due to handling or vehicle or aircraft operations.

In contrast to the above deficiencies, the disclosed micro-lamellar grating spectrometer has the ability to operate over the infrared spectrum where various laser sources are known to have signatures. Additionally, the disclosed spectrometer is ruggedized by having an increased natural resonant frequency; a feature not available in prior art lamellar interferometers.

The approach of the disclosed invention moves away from the resonant mode of operation used by current MEMS interferometer spectrometers and instead employs an inherently mechanically stiff actuator system such as a magnetic actuator using an actuation coil and permanent magnet, thermal or piezoelectric actuator means or similar configuration. Desirably, a magnetic actuator can be made small and compact and can achieve resonant frequencies of several KHz (versus a few hundred Hz of the existing MEMS interferometers).

As stated above, other types of stiff actuators are within the scope of the invention, including thermal and piezoelectric actuators as further discussed.

The disclosed interferometer for use with the sensor system of the invention uses a hybrid MEMS approach to achieve high resolution interferometry while maintaining small size, ruggedness and low power. Compared to the prior art MEMS lamellar interferometers reported in the literature, the spectrometer invention herein provides at least the following unique technological advantages:

Ultra-large mirror displacement: The interferometer of the invention may be configured to have a mirror element displacement of greater than 500 μm. Such displacement is considered “ultra-large” for MEMS devices since most MEMS structures are only a few millimeters long and typical relative mirror displacements in prior art devices may be only a few to tens of microns.

Sampling in uniform and discrete increments: One of the difficulties with operating a prior art interferometer in the resonant mode is the difficulty in sampling the interferogram signal in uniform and discrete intervals. This difficulty is coupled with the non-linearity of the mirror movement and requires that the interferogram data be pre-processed with special algorithms. The additional data processing introduces errors and reduces a system's sensitivity.

On the other hand, the interferometer of the invention operates in the non-resonant mode and allows the interferogram to be taken in pre-determined discrete increments or, for higher data rates, the interferometer of the invention can sample in the continuous mode.

High stiffness interferometer: Another difficulty with operating an interferometer in the resonant mode is that large mirror element displacement reduces system stiffness and lowers the system's natural frequency. An inverse relationship exists between a system's stiffness and displacement. By using an actuator with high stiffness and operating the interferometer in the non-resonant mode, the interferometer of the invention is able to de-couple this fixed relationship and permit both large mirror element displacement and high system stiffness to coexist.

Short response time: The magnetic actuators of the invention can respond quickly (i.e., in milliseconds). The fast response of a magnetic actuator permits the interferometer of the invention to incorporate closed-loop position feedback circuitry for precise mirror element positioning and for the triggering of detector sampling to produce an interferogram in a very short cycle time.

Miniature size: The small size of the lamellar grating produced using MEMS technology is retained, thus reducing the overall size of the spectrometer. MEMS processing and fabrication is exploited to produce the small and precise grating structures of the device. The same process may be used to produce the supporting structures and actuators. With the interferometer reduced in size, other components of the spectrometer are reduced to miniaturize the system.

Rugged system: A small and rugged spectrometer is realized. The low mass of the moveable mirror elements is combined with high stiffness actuators and non-resonant operation which means the overall spectrometer system is truly rugged and deployable in the field.

Low power: The instant interferometer with its low power magnetic actuator ensures low system power consumption and minimizes drain on a power source.

As earlier discussed, lamellar grating interferometry has been used previously for wavelengths in the far infrared (>50 μm) but for shorter wavelengths, the grating structure becomes too fine for conventional machining. However, MEMS technology provides an ideal fabrication process for producing the fine structures required for shorter IR wavelengths measured by the interferometer of the invention.

Turning now to FIGS. 4, 4a, 10, 10A and FIG. 11, a preferred embodiment of the micro-lamellar interferometer 605 of the invention for use with the sensor system of the invention is illustrated. Interferometer 605 generally comprises a lamellar grating 601 defined by two interleaved reflective mirror sets; a first stationary set of electromagnetically reflective (i.e., mirror) elements and a second moveable set of electromagnetically reflective elements. The first and second set of electromagnetically reflective elements are referred to as first stationary set of mirror elements 610 and second stationary set of mirror elements 615 herein.

The second mirror element set 615 is disposed on a platform that cooperates with and is driven by one or more flexures 625, which platform and flexure are driven in a vertical direction by actuator means 630. A preferred actuator means comprises a high stiffness magnetic actuator means for driving second mirror element 615 set vertically relative to first mirror set 610.

Flexures 625 may be configured as a plurality of cantilevered beams or, as seen in the figures, flexures 625 are a flexure or flexure system with a surface that is substantially coplanar or substantially parallel to the support assembly upon which the first mirror elements are disposed. In a preferred embodiment, flexures 625 are fabricated from a silicon material in a MEMS fabrication process and provide a flexure structure with desirable low hysteresis and yield.

Magnetic, thermal or piezoelectric actuator means or other high vertical displacement means are suitable actuator means and are configured to provide a predetermined vertical displacement, i.e., a second mirror set 615 displacement that is substantially perpendicular to first mirror set 610. A preferred embodiment of actuator means 630 provides a relative vertical displacement of about 500 μm.

Alternatively, the instant device can be designed to cover a broader range of wavelengths such as from visible to LWIR or other predetermined range of the electromagnetic spectrum as is known in the field of spectrometry. In selecting the wavelengths, consideration should be given to the atmospheric transmission (for remote detection), optical component interconnections (optical fiber) and the availability and cost of broadband electromagnetic detectors with high sensitivity.

As discussed earlier, prior art resonant-based interferometers generally have a fixed relationship between the mirror element displacement and system stiffness. The instant interferometer avoids this deficiency and uses a non-resonant system that decouples the system stiffness and displacement. By having a non-resonant system, the actuator of the invention has the benefit of high inherent stiffness, high resonant frequency, and can be used with any actuator means that offers ultra-large displacement and high inherent stiffness.

The high inherent predetermined stiffness of the flexure 625 of the invention permits mirror displacement or stroke travel distances unachievable in prior art MEMS-based interferometers that use, for instance, electrostatic comb drive mechanisms. Prior art electrostatic comb drive mechanisms are typically designed for travel of less than ten microns and travel distances of tens of microns are considered large in comb drive applications. One hundred microns stroke is considered very large travel in a prior art comb drive application.

The disclosed flexure arrangement using magnetic, piezoelectric or thermal actuator means permits a mirror travel distance of about 500 microns which is difficult, if not impossible, to achieve with state-of-the-art comb drive actuators due at least in part to the electrostatic comb drive structure's instability resulting from lateral forces.

Magnetic actuator means for displacement of the second set of moveable mirror elements 615 is well-suited for use in the instant lamellar grating interferometer. Magnetic actuators can be driven to very large displacements and when operating in the close-loop control, the actuator achieves high stiffness.

Advantages of the magnetic actuator include high stiffness, ultra-large displacement, short response time, fine displacement resolution and high actuation force.

As illustrated in FIGS. 10, 10A and the sectional view of FIG. 11, the grating 601 of first and second sets of mirror elements is located in about the center of the device. The two sets of mirror elements are interleaved to form the grating 601. In the illustrated embodiment, the mirror set on the “top” is a stationary mirror set 610 that is supported on a platform. Openings in the first stationary set of mirror elements 610 permits a second moveable set of mirror elements 615 to be slideably interleaved there between to define a lamellar grating 1.

In the illustrated embodiment, the second moveable set of mirror elements 615 is defined on a platform that is supported by flexures 625 on each side of grating 601. These flexures 625 are precisely etched in a MEMS process and are formed as an integral part of the platform. The flexures 625 ensure precise movement of the second set of moveable mirror elements 15 and can be configured to prevent them from coming in contact with lower surface the first stationary set of mirror elements 610.

In the magnetic actuator embodiment of FIGS. 10 and 10A, the magnetic actuator 630 may be defined by a set of actuation coils mounted on the lower surface of the second set of moveable mirror elements 615. The actuation coils are designed to cooperate with a permanent magnet that is positioned at a predetermined distance from the second set of moveable mirror elements 615. When electric current is passed through the actuation coils, the interaction between the current and the magnetic flux produces an electromotive force. The conventional expression for the magnetic force is expressed as:

Fm=I×B

Where Fm is the magnetic force; I is the current and B is the magnetic flux. All three parameters are vectors and the “x” is the cross-product operator. By suitably designing the actuation coil geometry and aligning the permanent magnet, a net force is generated. The magnitude of the force and hence displacement, is controlled by modulating the current flow.

An accurate determination of the second mirror set position over the full length of travel is a consideration for the interferometer in achieving high accuracy. Position feedback may be obtained in several ways including capacitive sensing, inductive sensing from the actuation coils (a stationary coil transmits AC magnetic field is needed) or the use of a laser reference system.

Very high forces are achievable using the magnetic actuator (sub-Newtons) embodiment. When combined with a high-bandwidth closed-loop control system, the system's natural frequency can reach several KHz.

In another embodiment, the use of thermal actuator means 630 provides an alternative moveable mirror set displacement means with high force and high displacement actuation. The thermal actuator embodiment takes advantage of the dissimilar expansion of two parallel beams 1000 to produce a “bi-morph” element bending.

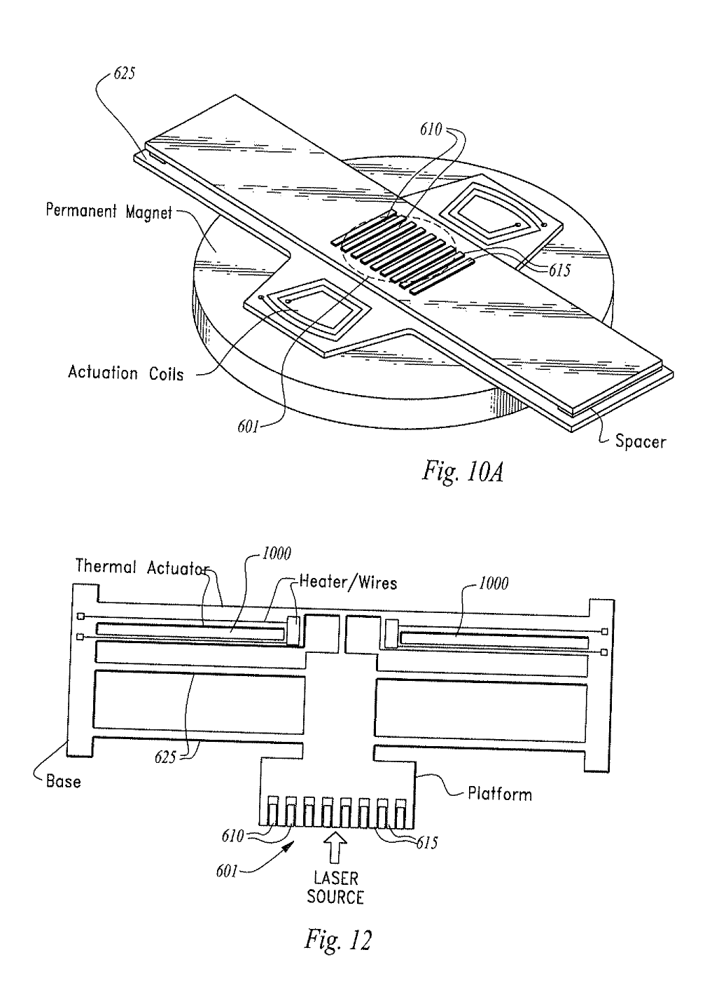

In the thermal actuator embodiment of FIG. 12, the tip of the bending beams in the thermal actuator achieves large vertical displacements. The two beams 1000 are designed with different widths, producing different rates of thermal conduction. The resulting difference in the thermal gradients produces the bending of beams 1000. An integral heater is provided on the thermal actuators to provide a means for introduction and control of the heat source. To actuate the second set of moveable mirror elements 615, an electrical current is passed through the heaters located on the thermal actuators.

As before, the lamellar grating 601 of the thermally-actuated embodiment is formed by two interleaved first stationary and second moveable sets of mirror elements. The second set of moveable mirror elements 615 is connected to a structure such as a platform supported by and driven by a pair of parallel flexures. The structure cooperates with and is driven by the thermal actuators. The first stationary set of mirror elements 610 is fixed to the substrate and is interleaved with the second set of moveable mirror elements 615.

Thermal actuators provide high displacement and high stiffness but unlike magnetic actuators, these two design parameters are not decoupled. In practice, the design of the actuator geometry is driven by actuation force and displacement and once these requirements are met, the stiffness of the actuators is fixed. Although optimization of the design can provide some compromise between displacement and stiffness, the de-coupling of these parameters is limited in this embodiment.

A concern with the use of thermal actuators is that the performance is sensitive to the thermal environment. Depending on the method of mounting and packaging chosen for device, the actuator displacement can vary as the temperature of the substrate changes. Careful design of the actuator and device packaging ensures consistent performance.

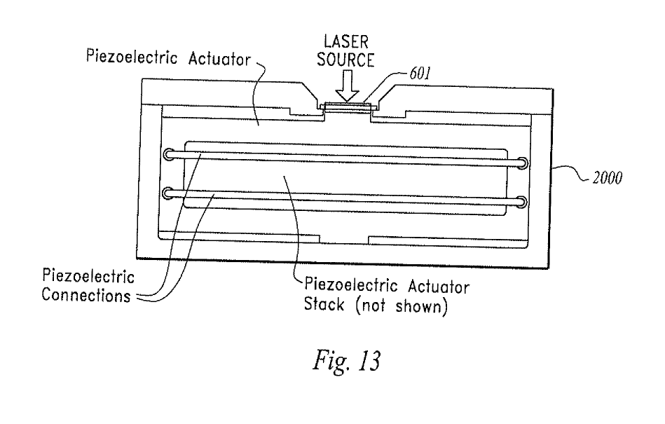

Yet a third preferred embodiment for producing an ultra-large displacement and high stiffness system is by using piezoelectric actuators as depicted in FIG. 13.

Chip scale integration of MEMS and piezoelectric actuators has been demonstrated at low displacements but displacements in the range of 500 μm require a large number of piezoelectric disks, making this embodiment difficult to achieve using chip scale integration in this embodiment. The alternative to chip scale integration is the use of commercially available, separately fabricated miniature piezoelectric actuators.

Commercially available piezoelectric actuators are designed and are commercially available in the form of a stack of piezoelectric disks integrated in a flexure frame for precise movement. An example of a suitable piezoelectric actuator means 630 is the FlexFrame PiezoActuator™ family of actuators produced by Dynamics Structures & Materials, LLC (Franklin, Tenn.). Depending on the size, these miniature actuators produce a displacement in excess of 500 μm. These piezoelectric actuators are relatively large compared to magnetic and thermal actuators, with the largest dimensions of a 500 μm actuator currently measuring about 46 mm×16 mm.

In addition to the ultra-large displacement, the piezoelectric actuators have very high stiffness. For actuators with a 500 μm movement, the stiffness is on the order of sub- to several Newtons per μm.

In the piezoelectric embodiment of FIG. 13, an external support frame 2000 may be used to support the stationary element of the grating 601, with the piezoelectric actuator attached to the second set of moveable mirror elements 615. The overall size of the device in this exemplar embodiment measures approximately 51 mm×22 mm (2.0 in×0.9 in).

A related issue with the piezoelectric embodiment shown in FIG. 13 is the sensitivity of the system to temperature changes. With the external frame and the piezoelectric actuator supporting different parts of the mirrors, any mismatch in the thermal expansion or contraction may cause a misalignment of the mirror sets, thus reducing the intensity of the interferometer. The effect of the mismatch can potentially be reduced by careful design and software compensation.

One or more interferometers 605 may be provided at any predetermined location or locations on the sensor system of the invention, the output or outputs of which can be used to determine the wavelength or wavelengths of an electromagnetic spectrometer input signal such as a laser designator source for analysis and appropriate response.

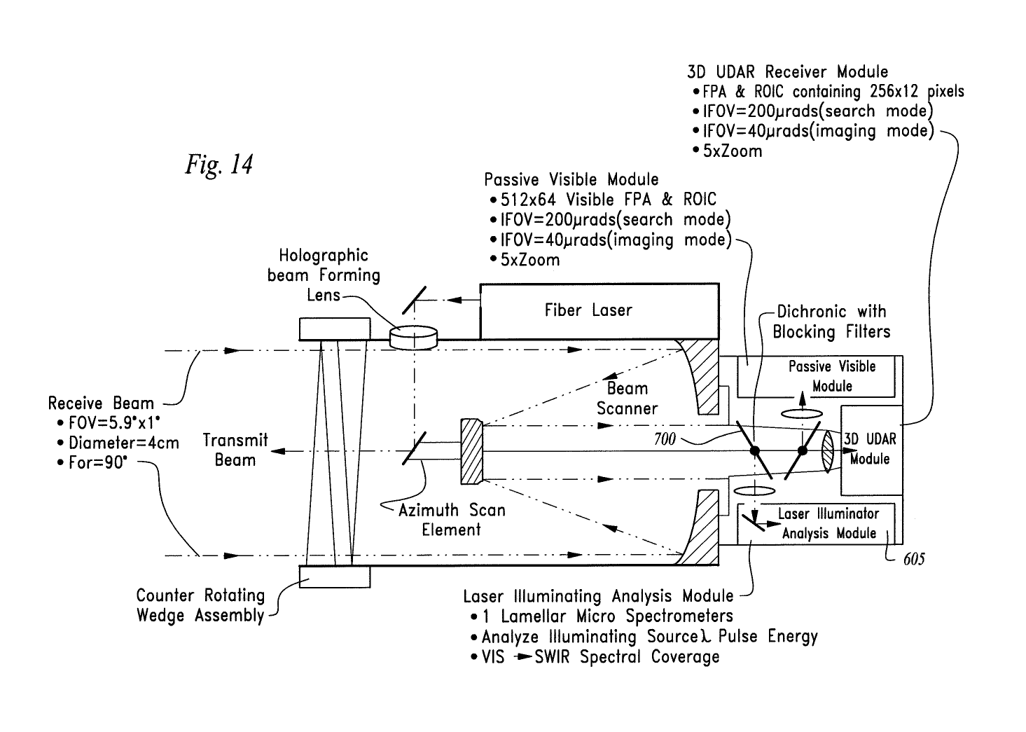

In one embodiment of the sensor system of the invention, the input to the spectrometer 605 may be an electromagnetic beam received from a dichroic filter element 700 provide as part of the optical path of the sensor system as depicted in FIG. 14.

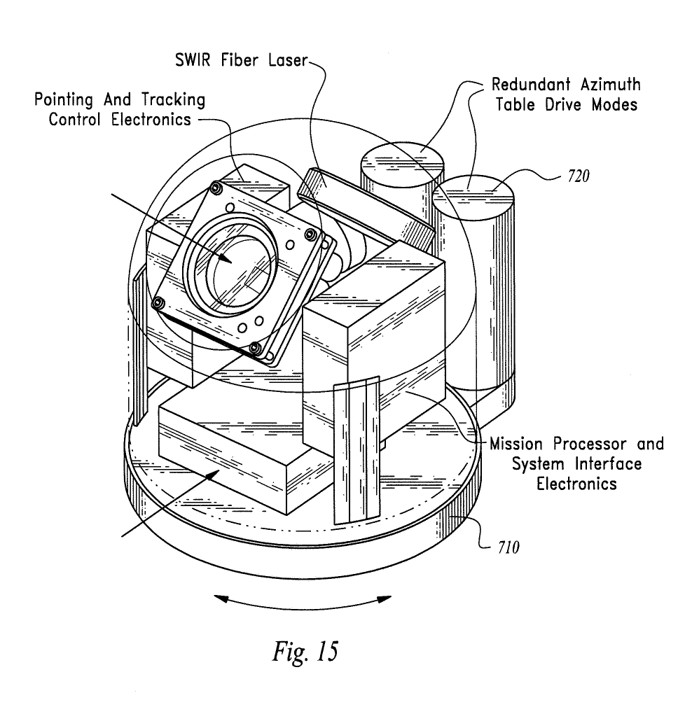

In a further embodiment, the sensor system of the invention may be mounted on a motorized rotating base or table 710 having one or more azimuth drive means 720 to permit the selective direction of the objective of the device toward a scene or target of interest which directing may be manual or controlled electronically. An exemplar embodiment of the sensor mounted on a rotating base is depicted in FIG. 15.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A sensor system comprising:
a first precision tracking element comprising imaging means for providing an electromagnetic illumination beam having a predetermined imaging wavelength and at least one precision tracking photo-detector element,
wherein at least one of the photo-detector elements comprises an electronic module comprising a stack of layers wherein the layers comprise a micro-lens array layer having at least one individual lens element for providing a beam output,
a photocathode layer for generating a photocathode electron output in response to a predetermined range of the electromagnetic spectrum,
a micro-channel plate layer comprising at least one micro-channel for generating a cascaded electron output in response to the photocathode electron output,
a readout circuit layer for processing the output of the micro-channel, and,
spectrometer means for determining the wavelength of an electromagnet imaging source.

2. The sensor system of claim 1 wherein the acquisition sensor element is mounted on a rotating base element that rotates about a first axis.

3. The sensor system of claim 1 wherein the precision tracking sensor element is movably mounted to a housing to permit the selective direction toward a predetermined scene of interest.

4. The sensor system of claim 1 further comprising at least one Risley prism assembly.

5. The sensor system of claim 1 comprising Gray code counter circuit means.

6. A sensor system comprising:
a first precision tracking element comprising imaging means for providing an electromagnetic illumination beam having a predetermined imaging wavelength, scanning means for scanning the illumination beam on a target, a parabolic reflector element, a hyperbolic reflector element, beam-splitting means, a first precision tracking photo-detector element responsive to a predetermined first range of the electromagnetic spectrum having a first active field of view, a second precision tracking photo-detector element responsive to a predetermined first range of the electromagnetic spectrum having a first passive field of view, and,
wherein at least one of the photo-detector elements comprises an electronic module comprising a stack of layers wherein the layers comprise a micro-lens array layer comprising at least one individual lens element for providing a beam output,
a photocathode layer for generating a photocathode electron output in response to a predetermined range of the electromagnetic spectrum,
a micro-channel plate layer comprising at least one micro-channel for generating a cascaded electron output in response to the photocathode electron output,
a readout circuit layer for processing the output of the micro-channel, and,
spectrometer means for determining the wavelength of an electromagnet imaging source.

7. The sensor system of claim 6 wherein the parabolic reflector element and the hyperbolic reflector element are configured as a Cassegrain reflector telescope assembly.

8. The sensor system of claim 6 wherein the illumination beam is projected through and incoming electromagnetic radiation is received through a common aperture.

9. The sensor system of claim 6 wherein at least one of the first and second precision tracking photo-detector elements comprises an electronic module comprising a stack of layers wherein the layers comprise,
a micro-lens array layer comprising at least one lens element for providing a beam output,
a photocathode layer for generating a photocathode electron output in response to a predetermined range of the electromagnetic spectrum,
a micro-channel plate layer comprising at least one micro-channel for generating a cascaded electron output in response to the photocathode electron output, and,
a readout circuit layer for processing the output of the micro-channel.

10. The sensor system of claim 6 wherein the readout circuit layer comprises a first sub-layer and a second sub-layer that are electrically coupled by means of a through-silicon via.

11. The sensor system of claim 6 further comprising a thermoelectric cooling layer.

12. The sensor system of claim 6 wherein the beam output of the lens element is substantially collimated.

13. The sensor system of claim 6 wherein the readout layer is comprised of a set of readout sub-layers comprising a capacitor top metal and analog preamp sub-layer, a filtering and comparator sub-layer and a digital processing sub-layer.

14. The sensor system of claim 6 wherein the predetermined ranges of the electromagnetic spectrum comprise ranges selected from the ultraviolet, visible, near-infrared, short-wave infrared, medium-wave infrared, long-wave infrared, far-infrared and x-ray ranges of the electromagnetic spectrum.

15. The sensor system of claim 6 wherein the micro-channel plate is comprised of at least one micro-channel having a diameter of less than about 10 microns.

16. The sensor system of claim 6 wherein the micro-channel plate is comprised of at least one micro-channel having a diameter of less than about five microns.

17. The sensor system of claim 6 wherein the acquisition sensor is mounted on a rotating base element that rotates about a first axis.

18. The sensor system of claim 6 wherein the precision tracking sensor element is movably mounted to a housing so as to be selectively directed toward a predetermined scene of interest.

19. The sensor system of claim 6 further comprising at least one Risley prism assembly.

20. The sensor system of claim 6 comprising Gray code counter circuit means.
